(19) United States
(12) Patent Application Publication
(10) Pub. No.: US 2018/0223947 A1
(43) Pub. Date: Aug. 9, 2018

(54) PAYLOAD SHOCK AND VIBRATION ISOLATOR

(71) Applicant: MOOG INC., East Aurora, NY (US)

(72) Inventors: John T. SHEPARD, Davis, CA (US); Timothy J. PARGETT, Sunnyvale, CA (US)

(21) Appl. No.: 15/748,523

(22) PCT Filed: Jul. 29, 2016
(86) PCT No.: PCT/US2016/044666

§ 371 Date: Jan. 29, 2018

Related U.S. Application Data
(60) Provisional application No. 62/202,628, filed on Aug. 7, 2015.

(51) Int. Cl. F16F 15/067; F16F 3/04; F16F 1/04

(52) U.S. Cl. CPC F16F 15/067; B64G 1/641; F16F 1/048; F16F 3/04

(57) ABSTRACT

A shock and vibration isolator comprising a housing securable to the support structure and having a rigid base, top and side portion, a traveler in the housing orientated about a longitudinal axis and configured to move axially and radially relative to the base portion of the housing, the traveler having a connection portion attachable to the payload and a radially-extending transfer portion, an upper, lower and radial non-rigid compliant element disposed axially between the top portion of the housing and the transfer portion of the rigid traveler, disposed axially between the base portion of the housing and the transfer portion of the traveler, and disposed radially between the side portion of the housing and the traveler, respectively, the non-rigid compliant elements operatively configured and arranged to selectively decouple axial and radial motion of the payload from axial and radial motion of the support structure.

### TECHNICAL FIELD

The present invention relates generally to mountings for supporting an aerospace payload relative to a supporting structure and more particularly to a payload shock and vibration isolator.

### BACKGROUND ART

Isolating payloads from the vibration and shock loading of a supporting structure or vehicle, or conversely isolating a structure or vehicle from an vibration inducing payload, is of concern to the aerospace industry.

U.S. Pat. No. 7,249,756 entitled “Low-profile, Multi-axis, Highly Passively Damped, Vibration Isolation Mount” is directed to a low-profile, multi-axis passively damped vibration isolation mount suitable for use in protecting hardware and payloads from damaging vibration and shock loads, particularly extreme loads seen in spacecraft launch systems.

U.S. Pat. No. 6,290,183 entitled “Three-axis, Six Degree-of-freedom, Whole-Spacecraft Passive Vibration Isolation System” is directed to a passive three-axis vibration isolation device suitable for effecting a six degree-of-freedom whole-spacecraft passive vibration isolation system.

U.S. Pat. No. 6,202,961 entitled “Passive, Multi-axis, Highly Damped, Shock Isolation Mounts for Spacecraft” is directed to a passive, multi-axis, highly damped, shock load isolation mount that serves as a one-piece mount, particularly of a spacecraft to its launch vehicle or launch vehicle adaptor structure and provides reduction in shock load transmission from a support base or structure to a payload for both axial loads and lateral loads. The disclosures of U.S. Pat. No. 7,249,756, U.S. Pat. No. 6,290,183 and U.S. Pat. No. 6,202,961 are hereby incorporated by reference in their entirety.

U.S. Pat. No. 3,721,417 entitle “Elastomeric Combination Shock and Vibration Isolator” is directed to an elastomeric mounting capable of both shock and vibration isolation comprising an elongated elastomeric tubular buckling column having one end adapted to be connected to a supporting structure.

U.S. Pat. No. 8,882,450 entitled “Device for Supporting and Securing a Piece of Equipment on an Aircraft Engine or Nacelle Case” is directed to a vibration damper that includes a first part secured to a case and a second coaxial part rigidly connected to a piece of equipment and a safety member configured to hold the damper in place in the event of a damper failure or breakage.

### DISCLOSURE OF THE INVENTION

With parenthetical reference to the corresponding parts, portions or surfaces of the disclosed embodiment, merely for purposes of illustration and not by way of limitation, a shock and vibration isolator (15) configured to act between a support structure (18) and a payload (16) is provided comprising: a housing (19) securable to the support structure and having a rigid base portion (20), a rigid top portion (22) and a rigid side portion (21); a rigid traveler (23) orientated about a longitudinal axis (x-x); the rigid traveler disposed in the housing and configured to move axially and radially relative to the rigid base portion of the housing; the rigid traveler having a connection portion (24) attachable to the payload and a radially-extending transfer portion (25); an upper non-rigid compliant element (26) disposed axially between the top portion of the housing and the transfer portion of the rigid traveler; a lower non-rigid compliant element (28) disposed axially between the base portion of the housing and the transfer portion of the traveler; the upper non-rigid compliant element and the lower non-rigid compliant element operatively configured and arranged to selectively decouple axial motion of the payload from axial motion of the support structure; and a radial non-rigid compliant element (29) disposed radially between the side portion of the housing and the traveler and operatively configured and arranged to selectively decouple radial motion of the payload and radial motion of the support structure.

The upper non-rigid compliant element may comprise an upper spring and the lower non-rigid compliant element may comprise a lower spring. The upper and lower springs may each comprise a wave spring or a coil spring. The radially-extending transfer portion of the traveler may comprise an upper annular seat (30) retaining a first end of the upper spring and a lower annular seat (31) retaining a first end of the lower spring. The upper and lower non-rigid compliant elements may each comprise a flexure or a elastomerically deformable element. The radial non-rigid compliant element may comprise an elastomerically deformable element and the elastomerically deformable element may comprise an elastomeric O-ring. The upper and lower non-rigid compliant elements may be operatively configured and arrange to selectively decouple radial motion of the payload from radial motion of the structure. The radial non-rigid compliant element may be configured and arranged to selectively decouple axial motion of the payload from axial motion of the structure. The isolator may further comprise a fastener (32) configured and arranged to rigidly attach the base portion of the housing to the support structure and the fastener may comprise a screw. The housing may be securable to the support structure via an adhesive or a weld and the connection portion of the traveler may be attachable to the payload via an adhesive or a weld. The connection portion of the traveler may comprise a threaded opening (33) configured to receive a corresponding threaded bolt (34). The radially-extending transfer portion of the traveler may comprise an annular flange. The annular flange of the radially-extending portion of the traveler may comprise an annular groove (35) and the radial non-rigid compliant element may comprise an elastomeric O-ring disposed in the annular groove of the traveler.

In another aspect, a shock and vibration isolator configured to act between a support structure and a payload is provided comprising: a housing securable to a support structure and having a rigid base portion, a rigid top portion and a rigid side portion; a rigid traveler disposed in the housing and configured to move axially and radially relative to the rigid base portion of the support structure of the housing; the rigid traveler having a connection portion attachable to a payload and a radially-extending transfer portion; an upper non-rigid compliant element disposed axially between the top portion of the housing and the transfer portion of the rigid traveler; a lower non-rigid compliant element disposed axially between the base portion of the housing and the transfer portion of the traveler; and the upper non-rigid compliant element and the lower non-rigid compliant element operatively configured and arranged to selectively decouple axial motion of the payload from axial motion of the support structure. The isolator may further comprise a radial non-rigid compliant element disposed radially between the side portion of the housing and the traveler and operatively configured and arranged to decouple radial motion of the payload from radial motion of the structure.

### BRIEF DESCRIPTION OF THE DRAWINGS

FIG. 1 is a side elevation view of an embodiment of an improved shock and vibration isolator acting between a support structure and a payload.

FIG. 2 is a top plan view of the improved system shown in FIG. 1.

FIG. 3 is a vertical cross-sectional view of the improved system shown in FIG. 2, taken generally on line B-B of FIG. 2.

FIG. 4 is an enlarged cross-sectional view of the top portion of the housing shown in FIG. 3.

FIG. 5 is an enlarged cross-sectional view of the traveler shown in FIG. 3.

FIG. 6 is an enlarged cross-sectional view of the base and side housing portions shown in FIG. 3.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., crosshatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

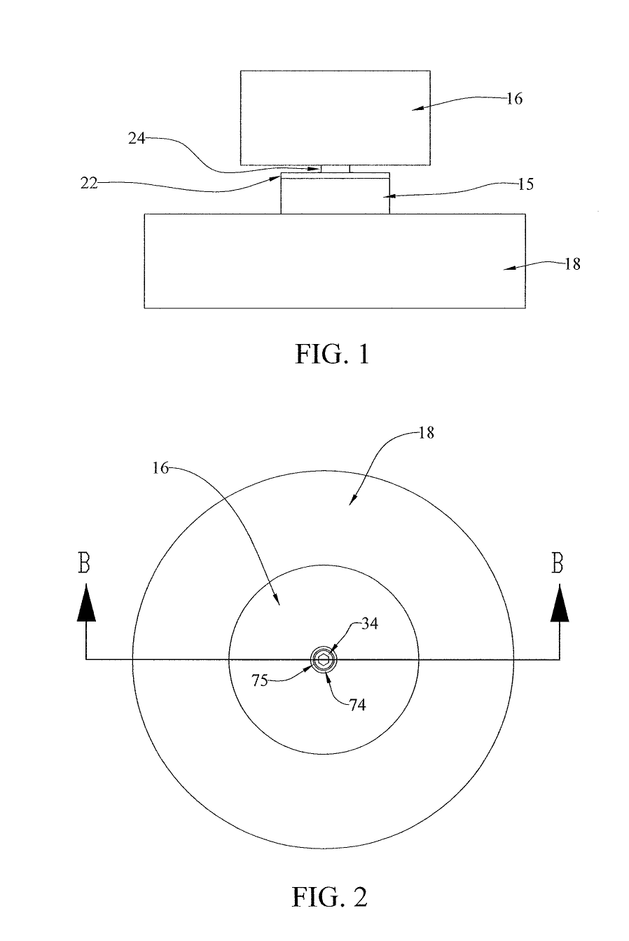

Referring now to the drawings, and more particularly to FIGS. 1-3 thereof, an improved shock and vibration isolator is provided, an embodiment of which is generally indicated at 15. As shown, isolator 15 acts between supporting structure 18 and payload 16 and generally comprises housing 19, traveler 23 disposed housing 19, upper wave spring 26 acting between traveler 23 and housing 19, lower wave spring 28 acting between traveler 23 and housing 19, and O-ring 29 acting between traveler 23 and housing 19.

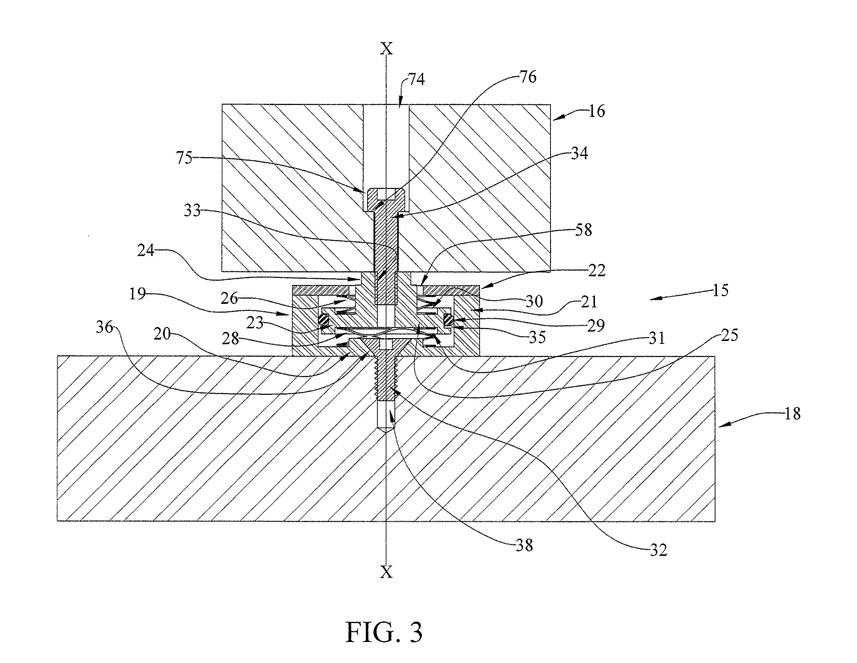

As shown in FIGS. 1 and 3, bolt 34 extending through opening 74 in payload 16 and having an outer threaded end in threaded engagement with inner threaded opening 33 in connection portion 24 of traveler 23 rigidly connects payload 16 to traveler 23. Counter-sunk screw 32 extending through opening 36 in base portion 20 of housing 19 and having an outer threaded end in threaded engagement with inner threaded opening 38 in support structure 18 rigidly connects housing 19 to support structure 18. While traveler 23 and housing 28 are shown as being connected to payload 16 and support structure 18, respectively, via threaded fixtures and connections, it is contemplated that other types of rigid connections may be used. For example, and without limitation, adhesive, welds, retaining rings, pins, crimps and other mechanisms which allow for traveler 23 to be fixedly connected and to move radially or laterally and axially with radial or lateral and axial movement of payload 16, and for housing 19 to be fixedly connected and to move radially or laterally and axially with radial or lateral and axial movement of support structure 18, respectively, may be employed as alternatives.

Upper spring 26, lower spring 28 and O-ring 29 between traveler 23 and housing 19 decouple both axial and radial or lateral motion of payload 16 from axial and radial or lateral motion of support structure 18 relative to longitudinal axis x-x.

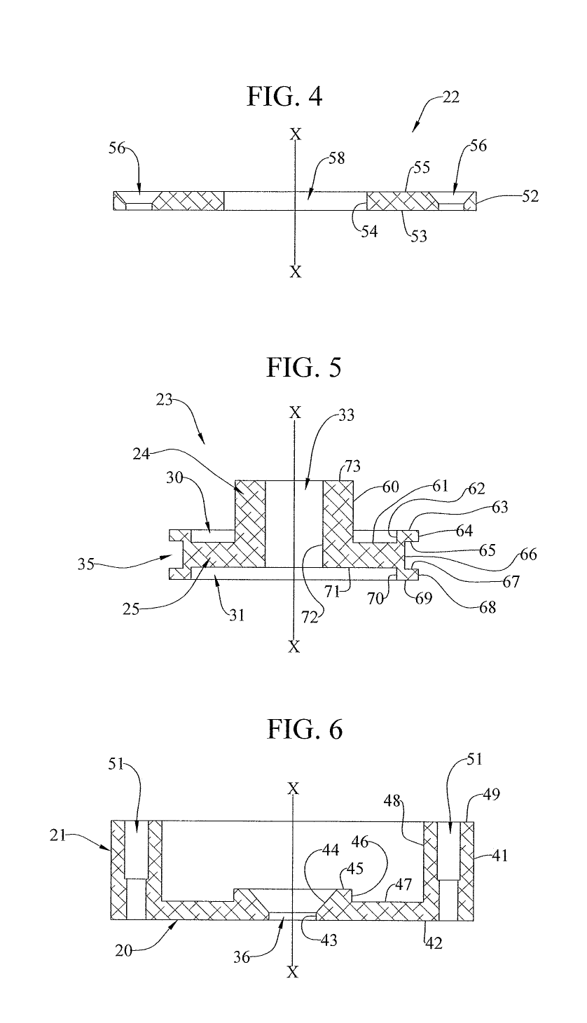

As shown in FIGS. 4 and 6, housing 19 generally comprises horizontal annular base portion 20, vertical cylindrical side wall 21 and horizontal annular top portion or cap 22. With reference to FIG. 4, cap 22 of housing 19 is a specially configured generally ring-shaped structure elongated along axis x-x, and generally bounded by outwardly-facing vertical cylindrical surface 52, downwardly-facing horizontal annular surface 53, inwardly-facing vertical cylindrical surface 54, and upwardly-facing horizontal annular surface 55, joined at its outer marginal end to the upper marginal end of surface 52. As shown, surface 54 generally defines an axial through-bore or orifice 58. Multiple counter-sunk holes, severally indicated at 56, are provided between surfaces 55 and 53 in cap 22 to receive screws for attaching cap 22 to side wall 21 of housing 19.

With reference to FIG. 6, base and side portions 20 and 21 of housing 19 comprise a specially-configured generally solid member elongated along axis x-x, and generally bounded by outwardly-facing vertical cylindrical surface 41, downwardly-facing horizontal annular surface 42, inwardly-facing vertical cylindrical surface 43, upwardly and inwardly-facing frusto-conical surface 44, upwardly-facing horizontal annular surface 45, outwardly-facing vertical cylindrical surface 46, upwardly-facing horizontal annular surface 47, inwardly-facing cylindrical surface 48, and upwardly-facing horizontal annular surface 49, joined at its outer marginal end to the upper marginal end of surface 41. As shown, side wall 21 of housing 19 includes multiple inner threaded bores, severally indicated at 51, which are configured to receive screws that attach cap 22. In this embodiment, six circumferentially spaced tapped threaded holes 51 are provided in side wall 21 of housing 19 and six corresponding counter-sunk holes 56 are provided in cap 22 of housing 19 to attach cap 22 to side wall 21 of housing 19. While cap 22 is shown as being connected to side wall 21 via threaded connections, it is contemplated that other types of connections may be used. For example, and without limitation, adhesive, welds, retaining rings, pins, crimps and other mechanisms which allow for cap 22 to be fixedly connected to side wall 21 of housing 19 may be employed as alternatives. As shown, surfaces 43 and 44 generally define an axial counter-sunk through-bore or hole 36, which receives screw 32 for attaching housing 19 to structure 18.

With reference to FIG. 5, traveler 23 is generally a specially configured cylindrical solid member elongated along axis x-x, and generally bounded by outwardly-facing vertical cylindrical surface 60, upwardly-facing horizontal annular surface 61, inwardly-facing vertical cylindrical surface 62, upwardly-facing horizontal annular surface 63, outwardly-facing vertical cylindrical surface 64, downwardly-facing horizontal annular surface 65, outwardly-facing vertical cylindrical surface 66, upwardly-facing horizontal annular surface 67, outwardly-facing vertical cylindrical surface 68, downwardly-facing horizontal annular surface 69, inwardly-facing vertical cylindrical surface 70, downwardly-facing horizontal annular surface 71, inwardly-facing vertical cylindrical surface 72, and upwardly-facing horizontal annular surface 73, joined at its outer marginal end to the upper marginal end of surface 60.

Surface 72 is threaded and generally defines opening 33, which receives payload bolt 34 in threaded engagement to rigidly connect payload 16 to traveler 23. A portion of surface 60 and surfaces 61 and 62 of traveler 23 generally define upper annular seat 30, which retains the lower end of upper spring 26. Similarly, surfaces 70 and 71 of traveler 23 define lower annular seat 31, which retains the upper end of spring 28. Surfaces 65, 66 and 67 of traveler 23 define annular groove 35, which retains O-ring 29. In this embodiment, the upper portion of surfaces 60 and surfaces 72 and generally define connection portion 24 of traveler 23 by which traveler 23 is affixed to payload 16. In this embodiment, surfaces 61-71 define radially-extending flange 25 of traveler 23 which supports upper spring 26, lower spring 28 and O-ring 29.

As shown in FIG. 3, payload 16 is fixedly connected to traveler 23 by bolt 34. Bolt 34 is inserted into through-hole 74 such that the hexagonal head 75 of bolt 34 bears against step 76 and the threaded end of bolt 34 protrudes from the bottom opening of bore 74 and engages inner threaded opening 33 of traveler 23. Bolt 34 is rotated until upper surface 73 of traveler 23 abuts and is held tightly against the bottom surface of payload 16, as shown in FIG. 3.

Counter-sunk flathead screw 32 fixedly connects housing 19 to support structure 18. Screw 32 is inserted into counter-sunk hole 36 in base portion 20 of housing 19 and the threaded end of screw 32 protrudes from the bottom opening of hole 36 and engages inner threaded opening 38 of support structure 18. Screw 32 is rotated until bottom surface 42 of base 20 of housing 19 abuts and is held tightly against the top surface of support structure 18, as shown in FIG. 3.

In this embodiment, upper and lower springs 26 and 28 are steel wave springs orientated about axis x-x. As shown in FIG. 3, wave spring 26 acts and is located axially between an annular portion of inner surface 53 of cap 22 of housing 19 and upper annular seat 30 in radial flange portion 25 of traveler 23. Similarly, lower wave spring 28 acts and is located axially between lower annular seat 31 in radial flange portion 25 of traveler 23 and a portion of annular surface 47 of base portion 20 of housing 19. In this embodiment, upper and lower springs 26 and 28 are both preloaded so as to bias traveler 23 downwardly and upwardly, respectively. Such bias on traveler 23 is countered by the opposing spring such that traveler 23 returns to a neutral position when no vibration or shock loads are applied. Thus, upper spring 26 is radially retained around axis x-x by upper annular seat 30 at its bottom end and in this embodiment is compressed axially directly between housing cap 22 and upper seat 30 of traveler 23. Lower spring 28 is radially retained about axis x-x by lower seat 31 in traveler 23 at its top end and is compressed axially directly between lower seat 31 of traveler 23 and housing base 20 of housing 19. Springs 26 and 28 provide variable resistance to axial motion of traveler 23 relative to housing 19 as well as some variable resistance to radial motion of traveler 23 relative to housing 19. The number of turns and waves of springs 26 and 28 can be easily adjusted to accommodate stronger force or meet desired operational requirements.

In this embodiment, O-ring 29 is an elastomeric deformable material orientated about axis x-x. As shown in FIG. 3, O-ring 29 acts between a cylindrical portion of inner surface 48 of side wall 21 of housing 19 and outer annular groove 35 in radial flange portion 25 of traveler 23. O-ring provides deformable resistance to radial motion of traveler 23 relative to housing 19 as well as frictional resistance to axial motion of traveler 23 relative to housing 19.

Thus, upper spring 26 and lower spring 28 between traveler 23 and housing 19 decouple both axial and radial motion of payload 16 from axial and radial motion of support structure 18 relative to longitudinal axis x-x. O-ring 29 between traveler 23 and housing 19 decouples both axial and radial motion of payload 16 from axial and radial motion of support structure 18 relative to longitudinal axis x-x. Wave springs 26 and 28 above and below traveler 23 create axial compliance to the load path. O-ring 29 around the circumference of traveler 23 creates lateral or radial compliance and also influences the axial compliance. These elements are contained within housing 19 that is mounted to support structure 18. The relative dimensions of the components of isolator 15 may be sized to provide appropriate preload to the compliant elements 26, 28 and 29 to achieve the desired dynamic characteristics of isolator 15. Whereas wave springs are typically used to apply compressive loads and O-rings are typically used for sealing fluids, in this embodiment these elements are used in a novel manner to create a compliant load path that provides isolation to payload 16.

While wave springs and elastomeric O-rings have been shown and described, other forms of compliance may be used. For example, and without limitation, coil springs or flexures may be used instead of wave springs and radial springs or flexures may be used instead of O-rings. The housing geometry may also be altered to incorporate the invention into a larger system or smaller system or to provide increased range of motion.

Isolator 15 provides a number of unexpected benefits. Isolator 15 has a limited number of elements and provides an efficient and cost effective means for adjusting axial, radial and tip-tilt stiffness. Isolator 15 provides enhanced performance versus cost, especially for aerospace systems. Isolator 15 is a modular device that has easily tunable parameters for different applications and various material choices for different environments. Isolator 15 provides mechanical isolation and does not require the sealing of fluids and preloaded valve assemblies. Isolator 15 provides a hybrid elastomeric-friction damping approach via the O-ring and wave springs and a hybrid elastomeric-metallic stiffness approach via the O-ring and wave springs.

While the presently preferred form of the improved isolator has been shown and described, and several modifications thereof discussed, persons skilled in this art will readily appreciate that various additional changes and modifications may be made without departing from the scope of the invention, as defined and differentiated by the claims.

What is claimed is:

1. A shock and vibration isolator configured to act between a support structure and a payload comprising:
a housing securable to a support structure and having a rigid base portion, a rigid top portion and a rigid side portion;
a rigid traveler orientated about a longitudinal axis;
said rigid traveler disposed in said housing and configured to move axially and radially relative to said rigid base portion of said housing;
said rigid traveler having a connection portion attachable to a payload and a radially-extending transfer portion;
an upper non-rigid compliant element disposed axially between said top portion of said housing and said transfer portion of said rigid traveler;
a lower non-rigid compliant element disposed axially between said base portion of said housing and said transfer portion of said traveler;
said upper non-rigid compliant element and said lower non-rigid compliant element operatively configured and arranged to selectively decouple axial motion of said payload from axial motion of said support structure; and
a radial non-rigid compliant element disposed radially between said side portion of said housing and said traveler and operatively configured and arranged to selectively decouple radial motion of said payload from radial motion of said support structure.

2. The isolator set forth in claim 1, wherein said upper non-rigid compliant element comprises an upper spring and said lower non-rigid compliant element comprises a lower spring.

3. The isolator set forth in claim 2, wherein said upper and lower springs each comprise a wave spring or a coil spring.

4. The isolator set forth in claim 3, wherein said radially-extending transfer portion of said traveler comprises an upper annular seat retaining a first end of said upper spring and a lower annular seat retaining a first end of said lower spring.

5. The isolator set forth in claim 1, wherein said upper and lower non-rigid compliant elements each comprise a flexure.

6. The isolator set forth in claim 1, wherein said radial non-rigid compliant element comprises an elastomerically deformable element.

7. The isolator set forth in claim 6, wherein said radial non-rigid compliant element comprises an elastomeric O-ring.

8. The isolator set forth in claim 1, wherein said upper and lower non-rigid compliant elements are operatively configured and arranged to selectively decouple radial motion of said payload from radial motion of said structure.

9. The isolator set forth in claim 1, wherein said radial non-rigid compliant element is configured and arranged to selectively decouple axial motion of said payload from axial motion of said structure.

10. The isolator set forth in claim 1, and further comprising a fastener configured and arranged to rigidly attach said base portion of said housing to said support structure.

11. The isolator set forth in claim 1, wherein said fastener comprises a threaded fastener.

12. The isolator set forth in claim 1, wherein said housing is securable to said support structure via an adhesive or a weld.

13. The isolator set forth in claim 1, wherein said connection portion of said traveler comprises a threaded opening configured to receive a corresponding threaded bolt.

14. The isolator set forth in claim 1, wherein said connection portion of said traveler is attachable to said payload via an adhesive or a weld.

15. The isolator set forth in claim 1, wherein said radially-extending transfer portion of said traveler comprises an annular flange.

16. The isolator set forth in claim 15, wherein said annular flange of said radially-extending transfer portion of said traveler comprises an annular groove and said radial non-rigid compliant element comprises an elastomeric O-ring disposed in said annular groove of said traveler.

17. A shock and vibration isolator configured to act between a support structure and a payload comprising:
a housing securable to a support structure and having a rigid base portion, a rigid top portion and a rigid side portion;
a rigid traveler disposed in said housing and configured to move axially and radially relative to said rigid base portion of said housing;
said rigid traveler having a connection portion attachable to a payload and a radially-extending transfer portion;
an upper non-rigid compliant element disposed axially between said top portion of said housing and said transfer portion of said rigid traveler;
a lower non-rigid compliant element disposed axially between said base portion of said housing and said transfer portion of said traveler; and
said upper non-rigid compliant element and said lower non-rigid compliant element operatively configured and arranged to selectively decouple axial motion of said payload from axial motion of said support structure.

18. The isolator set forth in claim 17, and further comprising a radial non-rigid compliant element disposed radially between said side portion of said housing and said traveler and operatively configured and arranged to decouple radial motion of said payload from radial motion of said structure.
